(19) United States
(12) Patent Application Publication
(10) Pub. No.: US 2025/0158649 A1
(43) Pub. Date: May 15, 2025

(54) RADIO WAVE CONTROL SYSTEM, CONTROL APPARATUS, CONTROL METHOD, AND NON-TRANSITORY COMPUTER READABLE MEDIUM

(71) Applicant: NEC Corporation, Minato- ku, Tokyo (JP)

(72) Inventors: Ryota Nihei, Tokyo (JP); Kenji Wakafuji, Tokyo (JP); Kohei Yoshida, Tokyo (JP); Junichi Funada, Tokyo (JP)

(73) Assignee: NEC Corporation, Minato- ku, Tokyo (JP)

(21) Appl. No.: 18/838,279

(22) PCT Filed: Mar. 8, 2022
(86) PCT No.: PCT/JP2022/009912

§ 371 Date: Aug. 14, 2024

(51) Int. Cl. H04B 1/10

(52) U.S. Cl. CPC H04B 1/1036

(57) ABSTRACT

The object is to provide a radio wave control system that is capable of suppressing radio wave interference. A radio wave control system according to the present disclosure includes a reflective plate (10) configured to reflect an undesired radio wave that causes interference for a communication apparatus, a control unit (21) that causes a reflected wave of the undesired radio wave to be transmitted in a direction in which the communication apparatus is present, and a communication unit (22) that receives interference information indicating an interference state in the communication apparatus, and the control unit (21) determines a phase of the reflected wave reaching the communication apparatus by using the interference information.

### TECHNICAL FIELD

The present disclosure relates to a radio wave control system, a control apparatus, a control method, and a non-transitory computer readable medium.

### BACKGROUND ART

A communications terminal establishes a connection with a base station to perform mobile communication. The communication terminal receives a signal transmitted from the base station by receiving a radio wave from the base station. The communication terminal may receive a radio wave from the base station different from the base station that has established the connection or a radio wave transmission source different from the base station. However, the radio wave received from the base station different from the base station that has established the connection or the radio wave transmission source different from the base station becomes noise or interfering radio wave, causing radio wave interference. As a result, communication quality between the communication terminal and the base station is deteriorated.

Patent Literature 1 discloses a configuration of a radio wave propagation environment control structure for improving quality of a radio wave propagation environment, which includes a transmission parabolic antenna and a reception parabolic antenna. Patent Literature 1 discloses a configuration in which an electromagnetic field sensitive functional body is loaded on the parabolic antenna or installed on a propagation path to change a reflection direction of a radio wave having an undesired frequency.

### CITATION LIST

### Patent Literature

Patent Literature 1: Japanese Unexamined Patent Application Publication No. 2013-143562

### SUMMARY OF INVENTION

### Technical Problem

However, in an environment where mobile communication is performed, the terminal receives undesired radio waves from various directions. Therefore, there is a problem that it is difficult to efficiently reduce the interference generated in the terminal even if the electromagnetic field sensitive functional body is used to change the reflection direction of the radio wave of the undesired frequency or absorb the radio wave of the undesired frequency.

In view of the above-described problems, it is an object of the present disclosure to provide a radio wave control system, a control apparatus, a control method, and a non-transitory computer readable medium, which are capable of suppressing radio wave interference.

### Solution to Problem

A radio wave control system according to a first aspect of the present disclosure includes a reflective plate configured to reflect an undesired radio wave that causes interference for a communication apparatus, a control means for causing a reflected wave of the undesired radio wave to be transmitted in a direction in which the communication apparatus is present, and a communication means for receiving interference information indicating an interference state in the communication apparatus, wherein the control means determines a phase of the reflected wave reaching the communication apparatus by using the interference information.

A control apparatus according to a second aspect of the present disclosure includes a control means for causing a reflected wave of an undesired radio wave, which is transmitted from a reflective plate configured to reflect the undesired radio wave that causes interference for a communication apparatus, to be transmitted in a direction in which the communication apparatus is present, and a communication means for receiving interference information indicating an interference state in the communication apparatus, wherein the control means determines a phase of the reflected wave reaching the communication apparatus by using the interference information.

A control method according to a third aspect of the present disclosure includes causing a reflected wave of an undesired radio wave, which is transmitted from a reflective plate configured to reflect the undesired radio wave that causes interference for a communication apparatus, to be transmitted in a direction in which the communication apparatus is present, receiving interference information indicating an interference state in the communication apparatus, and determining a phase of the reflected wave reaching the communication apparatus by using the interference information.

A program according to a fourth aspect of the present disclosure causes a computer to execute causing a reflected wave of an undesired radio wave, which is transmitted from a reflective plate configured to reflect the undesired radio wave that causes interference for a communication apparatus, to be transmitted in a direction in which the communication apparatus is present, receiving interference information indicating an interference state in the communication apparatus, and determining a phase of the reflected wave reaching the communication apparatus by using the interference information.

### Advantageous Effects of Invention

According to the present disclosure, it is possible to provide a radio wave control system, a control apparatus, a control method, and a non-transitory computer readable medium, which are capable of suppressing radio wave interference.

### BRIEF DESCRIPTION OF DRAWINGS

FIG. 1 is a configuration diagram of a radio wave control system according to a first example embodiment.

FIG. 2 is a flowchart regarding a phase determination process according to the first example embodiment.

FIG. 3 is a configuration diagram of a radio wave control system according to a second example embodiment.

FIG. 4 is a configuration diagram of a terminal apparatus according to the second example embodiment.

FIG. 5 is a configuration diagram of a control apparatus according to the second example embodiment.

FIG. 6 is a flowchart regarding a feedback process of the terminal apparatus according to the second example embodiment.

FIG. 7 is a flowchart regarding a phase control process of the control apparatus according to the second example embodiment.

FIG. 8 is a configuration diagram of a terminal apparatus according to a third example embodiment.

FIG. 9 is a configuration diagram of a control apparatus according to the third example embodiment.

FIG. 10 is a configuration diagram of a terminal apparatus according to a fifth example embodiment.

FIG. 11 is a configuration diagram of a control apparatus and a terminal apparatus according to each example embodiment.

### EXAMPLE EMBODIMENT

### First Example Embodiment

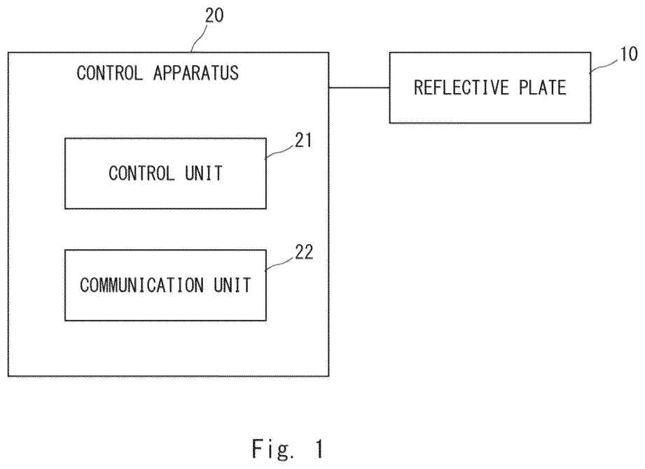

Example embodiments of the present disclosure will be described below with reference to the drawings. FIG. 1 is a configuration diagram of a radio wave control system according to a first example embodiment. The radio wave control system in FIG. 1 includes a reflective plate 10 and a control apparatus 20. The reflective plate 10 reflects radio waves. The control apparatus 20 controls the reflection direction of the radio wave in the reflective plate 10. In other words, the control apparatus 20 controls the direction of the reflected wave transmitted from the reflective plate 10. The control apparatus 20 may be a computer apparatus that operates when a processor executes a program stored in a memory.

The reflective plate 10 reflects undesired radio waves that cause interference to a communication apparatus. The communication apparatus may be, for example, a terminal apparatus that performs wireless communication with a base station, or may be a base station. Alternatively, the communication apparatus may be a terminal apparatus that performs wireless communication with a wireless local area network (LAN) access point, or may be a wireless LAN access point. The communication apparatus regards radio waves other than desired radio waves as undesired radio waves that cause interference. For example, in a case in which the communication apparatus is a terminal apparatus, the undesired radio wave may be a radio wave received by the terminal apparatus from a base station different from the base station to which the connection is established. Alternatively, for example, when the communication apparatus is a base station, the undesired radio wave may be a radio wave received by the base station from other base stations. The undesired radio waves are also referred to as interfering radio waves or noise.

The base station that transmits the undesired radio wave transmits radio waves not only in a specific direction but over a wide range of directions. Therefore, the reflective plate 10 installed at a position away from the communication apparatus also receives radio waves similar to the undesired radio wave received by the communication apparatus. In the following description, the undesired radio wave is an undesired radio wave for the communication apparatus other than not an undesired radio wave for the reflective plate 10.

Further, reflecting the undesired radio wave may be rephrased as transmitting the reflected wave of the undesired radio wave. That is, the reflective plate 10 receives the undesired radio wave and transmits the reflected wave of the undesired radio wave. Transmitting may be rephrased as emitting.

Next, a configuration example of the control apparatus 20 will be described. The control apparatus 20 includes a control unit 21 and a communication unit 22. The control unit 21 and the communication unit 22 may be software components or modules whose processing is carried out by causing the processor to execute the program stored in the memory. Alternatively, the control unit 21 and the communication unit 22 may be hardware components such as circuits or chips.

The control apparatus 20 may be used as an apparatus integrated with the reflective plate 10, or may be connected to the reflective plate 10 via a cable or the like. Although FIG. 1 illustrates a configuration in which the control apparatus 20 includes the control unit 21 and the communication unit 22, the control unit 21 and the communication unit 22 may be mounted on different apparatuses.

The control unit 21 causes the reflected wave of the undesired radio wave to be transmitted in the direction in which the communication apparatus is present. As a result, the communication apparatus receives the undesired radio waves from the transmission source of undesired radio waves, and further receives reflected waves of undesired radio waves from the reflective plate 10. The control unit 21 may determine a phase of the reflected wave by electrically controlling the reflective plate 10 and set a direction in which the communication apparatus is present as a transmission direction of the reflected wave. Specifically, the control unit 21 may determine the phase of the reflected wave in such a way that the reflected waves in the direction of the communication apparatus overlap and reinforce each other. Further, the phase of the reflected wave may be determined in such a way that the reflected waves in directions other than the direction of the communication apparatus are canceled and attenuated.

The communication unit 22 receives interference information indicating an interference state in the communication apparatus. The interference state may be information indicating the extent of interference occurring. For example, the interference state may be indicated by using a signal noise ratio (SNR) or a signal to interference plus noise power ratio (SINR). The communication unit 22 may receive the interference information from the communication apparatus via a mobile communication network, or may receive the interference information of the communication apparatus from a monitoring apparatus or the like monitoring the communication apparatus. The interference state may be measured in the communications apparatus.

The control unit 21 determines the phase of the reflected wave reaching the communication apparatus by using the interference information. For example, in a case in which the interference state in the communication apparatus is better than a predetermined state, the phase of the current reflected wave may not be changed. The current reflected wave may be a previously transmitted reflected wave. In a case in which the interference state in the communication apparatus is worse than the predetermined state, the phase of the current reflected wave is changed. The predetermined state may be determined using, for example, the SNR or the SINR. Alternatively, the control unit 21 may increase an amount of change in the phase of the reflected wave as the interference state in the communication apparatus worsens. Specifically, as the interference state in the communication apparatus worsens, the control unit 21 may increase a rotation amount of the phase of the reflected wave as compared with the reflected wave before whose phase is changed. The state in which the interference state in the communication apparatus is better than the predetermined state refers to a state in which the undesired radio wave and the reflected wave of the undesired radio wave cancel each other in the communication apparatus. Further, the state in which the interference state in the communication apparatus is worse than the predetermined state refers to a state in which the reflected wave of the undesired radio wave does not sufficiently cancel the undesired radio wave, or a state in which the phase of the reflected wave of the undesired radio wave overlaps the phase of the undesired radio wave to strengthen the undesired radio wave.

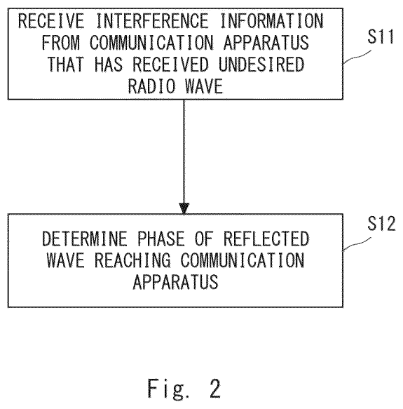

Next, a flowchart regarding a phase determination process according to the first example embodiment will be described with reference to FIG. 2. First, the communication unit 22 receives the interference information indicating the interference state in the communication apparatus that has received the undesired radio wave (S11). Next, the control unit 21 determines the phase of the reflected wave reaching the communication apparatus by using the interference information (S12).

As described above, the control apparatus 20 in FIG. 1 can determine the phase of the reflected wave transmitted from the reflective plate 10 in such a way that the undesired radio wave and the reflected wave of the undesired radio wave cancel each other in the communication apparatus. As a result, the control apparatus 20 can reduce the interference generated in a communication apparatus that receives the undesired radio waves.

### Second Example Embodiment

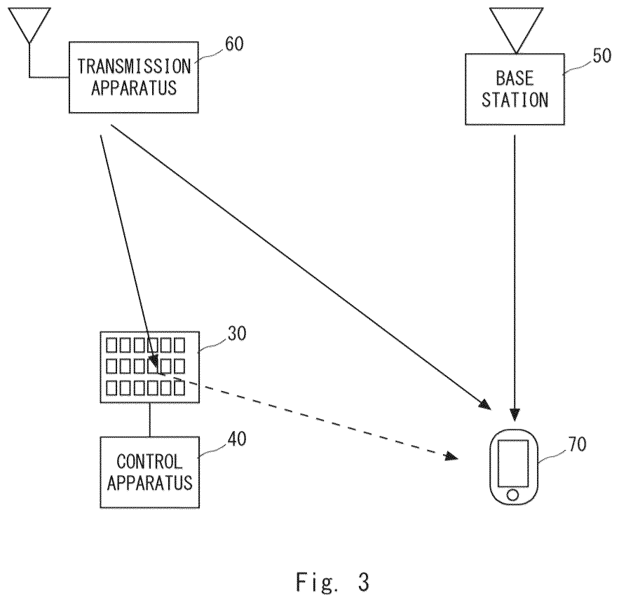

Next, a configuration example of a radio wave control system according to a second example embodiment will be described with reference to FIG. 3. The radio wave control system in FIG. 3 includes a reconfigurable intelligent surface (RIS) reflective plate 30, a control apparatus 40, a base station 50, a transmission apparatus 60, and a terminal apparatus 70. Solid line arrows in FIG. 3 indicate radio waves that directly reach the RIS reflective plate 30 or the terminal apparatus 70, or radio waves that are reflected by an obstacle or the like other than the RIS reflective plate 30 and reach the RIS reflective plate 30 or the terminal apparatus 70. A dotted line arrow in FIG. 3 indicates a radio wave reflected by the RIS reflective plate 30 or a reflected wave transmitted from the RIS reflective plate 30.

The terminal apparatus 70 is equivalent to the communication apparatus described in the first example embodiment. The terminal apparatus 70 may be a computer apparatus that operates when a processor executes a program stored in a memory. The terminal apparatus 70 may be a smartphone terminal or an Internet of Things (IoT) terminal. Alternatively, in a case in which the terminal apparatus 70 performs wireless LAN communication, it may be a client terminal having a wireless LAN communication function.

The terminal apparatus 70 establishes a connection with the base station 50 and performs wireless communication with the base station 50. The terminal apparatus 70 receives radio waves transmitted from the base station 50 as desired radio waves.

The transmission apparatus 60 is an apparatus that transmits radio waves, and may be, for example, a base station in a terrestrial network or a base station in a non-terrestrial network. The base station in the non-terrestrial network may be, for example, a satellite base station. The terminal apparatus 70 receives radio waves transmitted by the transmission apparatus 60 as the undesired radio waves. In the terminal apparatus 70, the communication quality between the terminal apparatus 70 and the base station 50 deteriorates due to interference between the desired radio wave and the undesired radio wave.

The RIS reflective plate 30 is a reflective plate in which a meta-surface technique is employed. The RIS reflective plate 30 may be referred to as a meta-surface reflective plate. In the RIS reflective plate 30, reflective elements capable of realizing any dielectric constant and magnetic permeability are periodically disposed on the surface of the reflective plate. The reflective element is a structure sufficiently small with respect to the wavelength of the radio wave, and may be, for example, a patch antenna.

The control apparatus 40 electrically controls the reflective elements disposed on the surface of the RIS reflective plate 30 such that the phase of the radio wave is switched to adaptively change the reflection direction of the radio wave. Switching the phase of the radio wave may be rephrased as changing the phase.

For example, the control apparatus 40 may switch the phase of the reflected wave by controlling a variable resonance circuit incorporated in the RIS reflective plate 30. Alternatively, in a case in which a plurality of materials having different reflection phases are disposed on the surface of the RIS reflective plate 30, the control apparatus 40 may switch the phases of the reflected waves by switching the materials used as the reflective elements. Alternatively, a liquid crystal layer may be disposed on the surface of the RIS reflective plate 30, and the control apparatus 40 may change the voltage applied to the RIS reflective plate 30 to control the dielectric constant such that the phase of the reflected wave is switched. The liquid crystal layer may be disposed for each reflective element.

The RIS reflective plate 30 reflects the radio waves transmitted from the transmission apparatus 60. The control apparatus 40 controls the phase of the reflected wave such that the radio wave is reflected in the direction in which the terminal apparatus 70 is present. That is, the control apparatus 40 controls the phase such that the radio waves reflected by a plurality of reflective elements reinforce each other in the direction in which the terminal apparatus 70 is present. The control apparatus 40 controls the phase of the reflected wave for each reflective element. That is, the phase of the reflected wave transmitted from the reflective element is different for each reflective element.

The reflected waves are used to weaken the undesired radio waves reaching the terminal apparatus 70 from the transmission apparatus 60 and reduce interference between the desired waves and the undesired radio waves generated in the terminal apparatus 70.

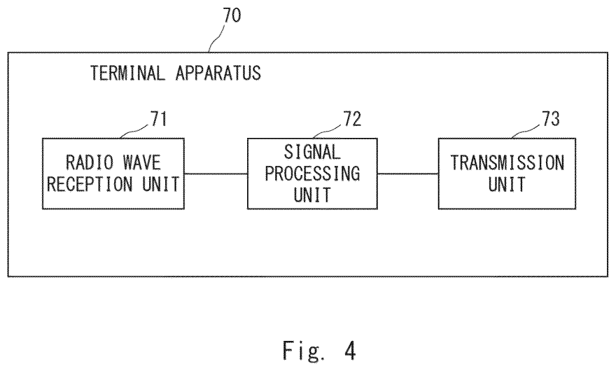

Next, a configuration example of the terminal apparatus 70 will be described with reference to FIG. 4. The terminal apparatus 70 includes a radio wave reception unit 71, a signal processing unit 72, and a transmission unit 73. The radio wave reception unit 71, the signal processing unit 72, and the transmission unit 73 may be software or a module in which a process is executed by a processor executing a program stored in a memory. Alternatively, the radio wave reception unit 71, the signal processing unit 72, and the transmission unit 73 may be hardware such as a circuit or a chip. The radio wave reception unit 71 and the transmission unit 73 may have an antenna for receiving or transmitting radio waves.

The radio wave reception unit 71 receives the radio waves. In other words, the radio wave reception unit 71 receives radio signals transmitted using the radio waves. The radio waves received by the radio wave reception unit 71 include the desired radio waves and the undesired radio waves.

The signal processing unit 72 demodulates the radio signals. Further, the signal processing unit 72 measures the SNR or the SINR of the demodulated signal and determines the interference state. The interference state may be a value of the SNR or the SINR, or may be information indicating a level of interference. For example, the level may be represented by an integer of 0 or more, and the higher the level of interference, the greater the influence of interference. For example, a plurality of thresholds related to the SNR or the SINR may be set in advance, and the level of interference may be set using each threshold. For example, in a case in which the SNR has a value between a certain threshold and another threshold, it may be indicated by level_A or the like (A is an integer of 0 or more).

The radio signal may include information about the radio wave transmitted by the base station 50. The information about the radio wave transmitted by the base station 50 may include specifications of the radio wave transmitted by the base station 50. The specifications of the radio wave transmitted by the base station 50 may include, for example, the position of the base station 50, the frequency of the radio wave transmitted by the base station 50, and phase information of the radio wave transmitted by the base station 50. The phase information of the radio wave may be, for example, information indicating a phase when the base station 50 transmits the radio wave.

The transmission unit 73 transmits information indicating the specifications, the interference state, and the necessity of canceling of the received radio wave received by the radio wave reception unit 71 to the control apparatus 40. The transmission unit 73 may perform wireless communication to transmit information to the control apparatus 40. For example, the transmission unit 73 may transmit information to the control apparatus 40 via the base station 50. In this case, it is assumed that the control apparatus 40 is connected to a network constructed by a communication service provider that manages the base station 50. Alternatively, the transmission unit 73 may perform wireless communication using a frequency different from the frequency used for communication with the base station 50, and transmit information to the control apparatus 40.

The specifications of the received radio wave may include specifications of the desired radio waves that are the radio waves transmitted by the base station 50. The interference state may be a value of the SNR or the SINR, or may be information indicating a level of interference state. The necessity of canceling may be information indicating whether or not it is necessary to reduce interference in the terminal apparatus 70. For example, in a case in which the SNR or the SINR falls below a predetermined threshold value, the signal processing unit 72 may determine that canceling is necessary because interference is occurring. In a case in which the SNR or the SINR exceeds a predetermined threshold value, the signal processing unit 72 may determine that canceling is unnecessary because no interference is occurring or the influence of the interference is small.

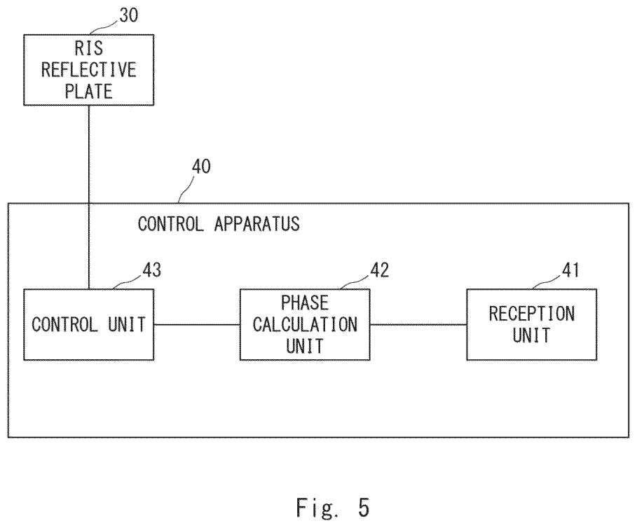

Next, a configuration example of the control apparatus 40 according to the second example embodiment will be described with reference to FIG. 5. The control apparatus 40 includes a reception unit 41, a phase calculation unit 42, and a control unit 43. The reception unit 41, the phase calculation unit 42, and the control unit 43 may be software or a module in which a process is executed by executing a program. Alternatively, the reception unit 41, the phase calculation unit 42, and the control unit 43 may be hardware such as a circuit or a chip.

The reception unit 41 receives information indicating the specifications of the received radio wave, the interference state, and the necessity of canceling from the terminal apparatus 70.

In a case in which the necessity of canceling indicates that canceling is necessary, the phase calculation unit 42 changes the phase of the reflected wave on the basis of the SNR or the SINR. For example, as the SINR indicates a smaller value, the phase calculation unit 42 may increase the rotation amount of the phase of the reflected wave since the influence of interference in the terminal apparatus 70 increases. As the SINR indicates a larger value, the phase calculation unit 42 may reduce the rotation amount of the phase of the reflected wave since the influence of interference in the terminal apparatus 70 decreases.

Alternatively, in a case in which the necessity of canceling indicates that canceling is necessary, the phase calculation unit 42 may change the phase of the reflected wave on the basis of the information indicating the level of the interference state. For example, as the level of the interference state indicates that the influence of interference is larger, the phase calculation unit 42 may increase the rotation amount of the phase of the reflected wave. As the level of the interference state indicates that the influence of interference is smaller, the phase calculation unit 42 may reduce the rotation amount of the phase of the reflected wave.

The control unit 43 electrically controls the reflective elements disposed on the surface of RIS reflective plate 30 such that the phase of the reflected wave of the undesired radio wave in the RIS reflective plate 30 becomes the phase determined by the phase calculation unit 42.

The terminal apparatus 70 repeats the determination of the interference state and the necessity of canceling at least once, and transmits the determination result to the control apparatus 40. The control apparatus 40 performs phase control on the basis of the measurement result received from the terminal apparatus 70. By repeating the phase control, the control apparatus 40 causes the reflected wave capable of reducing the interference in the terminal apparatus 70 to be transmitted from the RIS reflective plate 30.

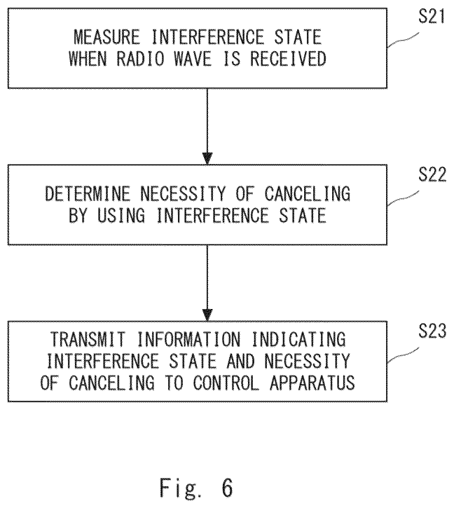

Next, a flowchart regarding feedback processing of the terminal apparatus 70 according to the second example embodiment will be described with reference to FIG. 6. First, the signal processing unit 72 measures the interference state using the received radio wave (S21). Then, the signal processing unit 72 determines the necessity of canceling by using the interference state (S22). Then, the transmission unit 73 transmits information indicating the interference state and the necessity of canceling to the control apparatus 40 (S23). The terminal apparatus 70 performs a feedback process of FIG. 6 each time the radio wave is received. Alternatively, in a case in which it is determined that canceling is unnecessary once, the terminal apparatus 70 may not perform the feedback process of FIG. 6. For example, in a case in which the terminal apparatus 70 is a terminal that is not moving and it is determined that canceling is unnecessary, there is a high likelihood that the state in which the interference is reduced continues thereafter, and thus the terminal apparatus 70 may make a decision not to perform the feedback process.

Here, in step S22, in a case in which the signal processing unit 72 determines that canceling is unnecessary, the transmission unit 73 may not transmit the information indicating the interference state to the control apparatus 40. Furthermore, when the control apparatus 40 determines the necessity of canceling, the signal processing unit 72 may not determine the necessity of canceling in step S22, and the transmission unit 73 may transmit the information indicating the interference state without transmitting the information indicating the necessity of canceling in step S23.

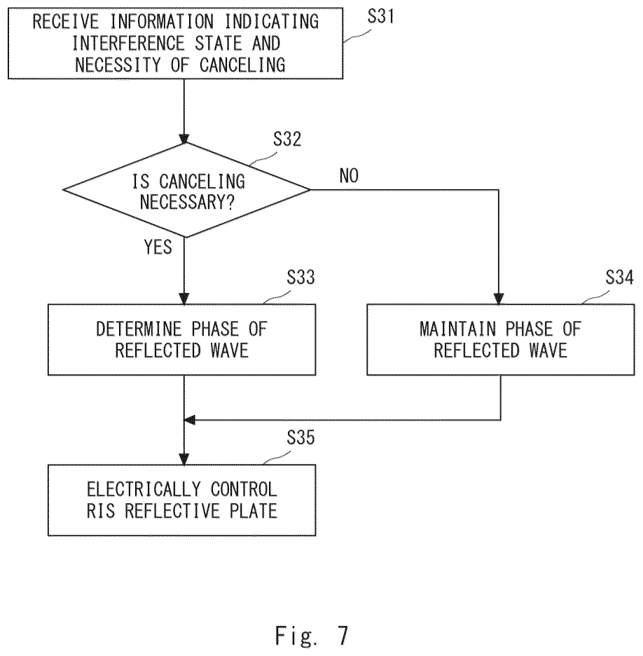

Next, a flowchart regarding the phase control process executed in the control apparatus 40 according to the second example embodiment will be described with reference to FIG. 7. First, the reception unit 41 receives the information indicating the interference state and the necessity of canceling from the terminal apparatus 70 (S31). Then, in a case in which it is indicated that canceling is necessary in the terminal apparatus 70 (S32), the phase calculation unit 42 determines the phase of the reflected wave by using the interference state (S33). In a case in which it is indicated that canceling is unnecessary in the terminal apparatus 70 (S32), the phase calculation unit 42 maintains the phase of the current reflected wave. That is, the phase calculation unit 42 uses the phase of the reflected wave determined so far (S34).

Next, the control unit 43 electrically controls the reflective elements disposed on the surface of RIS reflective plate 30 so as to become the phase determined by the phase calculation unit 42 (S35). The control unit 43 may determine the necessity of canceling by using the interference state. In a case in which the control unit 43 determines the necessity of canceling, the information indicating the necessity of canceling received from the terminal apparatus 70 may be discarded, or a notification that transmission of the information indicating the necessity of canceling is unnecessary may be given to the terminal apparatus 70.

As described above, the control apparatus 40 controls the phase of the reflected wave transmitted from the RIS reflective plate 30 by using the information indicating the interference state and the necessity of canceling received from the terminal apparatus 70. The control apparatus 40 can determine the phase of the reflected wave capable of reducing the interference in the terminal apparatus 70 by controlling the phase of the repeatedly reflected wave. As a result, the interference in the terminal apparatus 70 is reduced, and the communication quality between the terminal apparatus 70 and the base station 50 can be maintained good.

### Third Example Embodiment

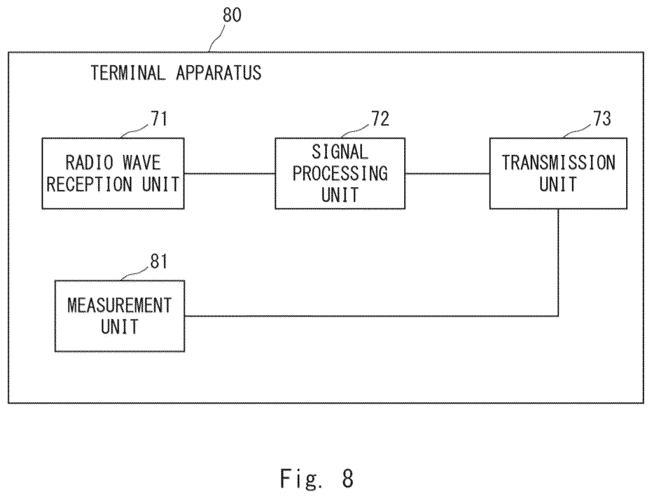

Next, a configuration example of the terminal apparatus 80 according to the third example embodiment will be described with reference to FIG. 8. The terminal apparatus 80 has a configuration in which a measurement unit 81 is added to the terminal apparatus 70 in FIG. 4. In the following description, configurations, functions, and operations of the terminal apparatus 80 which are different from those of the terminal apparatus 70 will be mainly described, and description of a configuration and the like similar to those of the terminal apparatus 70 will be omitted.

The measurement unit 81 measures the position of the terminal apparatus 80. For example, the measurement unit 81 may measure the position of the terminal apparatus 80 by using a global positioning system (GPS). Alternatively, the measurement unit 81 may measure or estimate the position of the terminal apparatus 80 by using the desired radio wave received from the base station 50.

Furthermore, the measurement unit 81 may detect pose information of the terminal apparatus 80. The pose information of the terminal apparatus 80 may be, for example, information indicating a direction in which the terminal apparatus 80 faces and an inclination of the terminal apparatus 80 with respect to a plane parallel to the ground surface. The direction in which the terminal apparatus 80 faces may be, for example, a direction defining the front of the terminal apparatus 80 or a direction in which the front of the terminal apparatus 80 faces.

Furthermore, the measurement unit 81 may detect movement information of the terminal apparatus 80. The movement information may be, for example, information indicating whether the terminal apparatus 80 is moving or stationary. Furthermore, the movement information may be information indicating a movement speed in a case in which the terminal apparatus 80 is moving. The measurement unit 81 outputs the measured information and the detected information to the transmission unit 73.

The transmission unit 73 transmits the information received from the measurement unit 81 to the control apparatus 90. The transmission unit 73 may transmit the information received from the measurement unit 81 to the control apparatus 90 together with the specifications of the received radio wave, the interference state, and the information indicating the necessity of canceling. Alternatively, the transmission unit 73 may transmit the information received from the measurement unit 81 to the control apparatus 90 as a radio signal different from the information indicating the specifications of the received radio wave, the interference state, and the necessity of canceling.

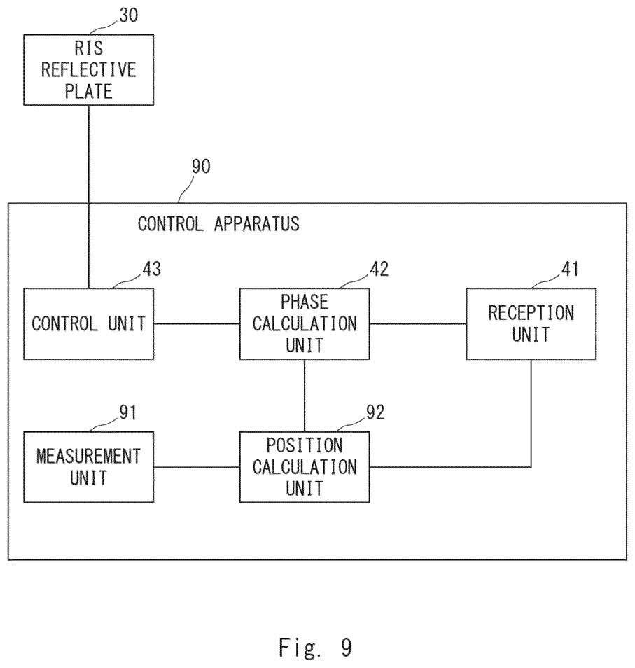

Next, a configuration example of the control apparatus 90 according to the third example embodiment will be described with reference to FIG. 9. The control apparatus 90 has a configuration in which a measurement unit 91 and a position calculation unit 92 are added to the control apparatus 40 of FIG. 5. In the following description, configurations, functions, and operations of the control apparatus 90 which are different from those of the control apparatus 40 will be mainly described, and description of a configuration and the like similar to those of the control apparatus 40 will be omitted.

The reception unit 41 receives information indicating the specifications of the received radio wave, the interference state, and the necessity of canceling from the terminal apparatus 80. Furthermore, the reception unit 41 receives the position information of the terminal apparatus 80 from the terminal apparatus 80. The reception unit 41 may receive the pose information and the movement information of the terminal apparatus 80 together with the position information of the terminal apparatus 80.

The measurement unit 91 measures the position of the control apparatus 90. For example, the measurement unit 91 may measure the position of the control apparatus 90 using a global positioning system (GPS).

The position calculation unit 92 receives the position information of the terminal apparatus 80 from the reception unit 41 and receives the position information of the control apparatus 80 from the measurement unit 91. In a case in which the control apparatus 90 is a stationary apparatus and the position is determined, the position calculation unit 92 may retain the position information of the control apparatus 90 in advance. In this case, the measurement unit 91 does not need to measure the position of the control apparatus 90.

The position calculation unit 43 calculates the distance between the RIS reflective plate 30 and the terminal apparatus 80 by using the position information of the terminal apparatus 80 and the position information of the control apparatus 90. Here, it is assumed that the position of the RIS reflective plate 30 is the same as the position of the control apparatus 90.

In a case in which the necessity of canceling indicates that canceling is necessary, the phase calculation unit 42 changes the phase of the reflected wave on the basis of the SNR or the SINR and the distance between the RIS reflective plate 30 and terminal apparatus 80. For example, as the SINR indicates a smaller value, the influence of interference caused by the undesired radio waves in the terminal apparatus 70 is larger. Therefore, the phase calculation unit 42 determines the phase of the reflected wave when the reflected wave reaches the terminal apparatus 80 such that the difference between the phase of the reflected wave when the reflected wave before whose phase is changed reaches the terminal apparatus 80 and the phase of the reflected wave when the reflected wave after whose phase has been changed reaches the terminal apparatus 80 becomes larger. Furthermore, the phase calculation unit 42 calculates the phase of the reflected wave transmitted from the RIS reflective plate 30 so that the reflected wave transmitted from the RIS reflective plate 30 becomes the determined phase when the reflected wave reaches the terminal apparatus 80 which is at a position separated by the distance calculated by the position calculation unit 92. The reflected wave transmitted from the RIS reflective plate 30 reaches the terminal apparatus 80 while rotating the phase. Therefore, the phase calculation unit 42 calculates the phase of the reflected wave upon transmission from the RIS reflective plate 30 on the basis of the distance between the RIS reflective plate 30 and the terminal apparatus 80.

Further, as the SINR indicates a larger value, the influence of interference in the terminal apparatus 70 is smaller. Therefore, the phase calculation unit 42 determines the phase of the reflected wave when the reflected wave reaches the terminal apparatus 80 such that the difference between the phase of the reflected wave when the reflected wave before change reaches the terminal apparatus 80 and the phase of the reflected wave when the reflected wave after change reaches the terminal apparatus 80 becomes smaller.

The control unit 43 controls the phase of the reflected wave upon transmission from the RIS reflective plate 30 on the basis of the calculation result in the phase calculation unit 42.

Furthermore, the control unit 43 may control the amplitude of the reflected wave. As the distance between the RIS reflective plate 30 and the terminal apparatus 80 increases, the signal strength of the reflected wave decreases. The signal strength of the reflected wave may be rephrased as a signal level, a reception level in the terminal apparatus 80, the amplitude, or the like. Therefore, for example, the control unit 43 may increase the number of reflective elements to be operated in the RIS reflective plate 30 as the distance between the RIS reflective plate 30 and the terminal apparatus 80 increases. In the above description, the example in which the control apparatus 90 controls one RIS reflective plate 30 has been described, but the control apparatus 90 may control a plurality of RIS reflective plates 30. In this case, the control unit 43 may increase the number of RIS reflective plates 30 to be operated as the distance between the RIS reflective plate 30 and the terminal apparatus 80 increases. As described above, as the distance between the RIS reflective plate 30 and the terminal apparatus 80 increases, the signal strength of the reflected waves can be increased by increasing the number of reflected waves.

Furthermore, the control unit 43 may control the phase of the reflected wave by using the pose information or the movement information of the terminal apparatus 80 together with the information indicating the distance between the RIS reflective plate 30 and the terminal apparatus 80. The higher the frequencies of the undesired radio waves and the reflected waves of the undesired radio waves, the shorter the wavelength of the radio waves. Therefore, as the pose of the terminal apparatus 80 changes and the terminal apparatus 80 moves, the rotation amount of the phase when the reflected wave reaches the terminal apparatus 80 also greatly changes. Therefore, the control unit 43 may determine the phase of the reflected wave upon reaching the terminal apparatus 80 by using at least one of the pose information and the movement information of the terminal apparatus 80.

As described above, the control apparatus 90 according to the third example embodiment determines the phase of the reflected wave in consideration of the distance between the RIS reflective plate 30 and the terminal apparatus 80. Accordingly, the control apparatus 90 determines the phase of the reflected wave reaching the terminal apparatus 80, and thus, it is possible to efficiently reduce the interference generated in the terminal apparatus 80 due to the undesired radio waves.

### Fourth Example Embodiment

Next, functions and operations of the control apparatus 20 according to the fourth example embodiment will be described. Since the configuration of the control apparatus 20 is similar to that in FIG. 1, functions and operations different from the functions and operations of the control apparatus 20 described in FIG. 1 will be mainly described.

The control unit 21 controls the reflective plate 10 such that the reflected wave of the undesired radio wave is transmitted in the direction in which the communication apparatus is present. Further, the control unit 21 determines the phase of the reflected wave reaching the communication apparatus by using the information indicating the phase when the undesired radio wave reaches the communication apparatus and the information indicating the distance from reflective plate 10 to the communication apparatus.

The control unit 21 may specify the information indicating the phase when the undesired radio wave reaches the communication apparatus on the basis of the information received by the communication unit 22 from the apparatus transmitting the undesired radio wave. Alternatively, the control unit 21 may specify the information indicating the phase when the undesired radio wave reaches the communication apparatus on the basis of the information received from the apparatus in which the communication unit 22 manages the information about the undesired radio wave.

For example, the control unit 21 may specify the information indicating the phase when the undesired radio wave reaches the communication apparatus by using the phase when the apparatus transmitting the undesired radio wave transmits the undesired radio wave and the distance between the apparatus transmitting the undesired radio wave and the communication apparatus.

Furthermore, the control unit 21 may specify the information indicating the distance from the reflective plate 10 to the communication apparatus by using the position information of the reflective plate 10 and the position information of the communication apparatus.

The reflected wave is used to cancel the undesired radio waves in the communication apparatus and reduce the interference generated in the communication apparatus. The control unit 21 determines the phase of the reflected wave transmitted from the reflective plate 10 so that the reflected wave transmitted from the reflective plate 10 becomes a phase in which undesired radio waves reaching the communication apparatus can be canceled when the reflected wave reaches the communication apparatus. For example, the control unit 21 determines the phase of the reflected wave transmitted from the reflective plate 10 so that the wavelength of the reflected wave upon reaching the communication apparatus is shifted by half a wavelength compared to the wavelength of the undesired radio wave reaching the communication apparatus. In other words, the control unit 21 determines the phase of the reflected wave transmitted from the reflective plate 10 so that the phase of the reflected wave upon reaching the communication apparatus is shifted by 180 degrees compared to the phase of the undesired radio wave upon reaching the communication apparatus.

Here, there are cases in which the reflected wave is not able to cancel the undesired radio waves reaching the communication apparatus, reinforcing the interference generated in the communication apparatus. For example, as the communication apparatus moves, the phase of the reflected wave may overlap the phase of the undesired radio wave, and the undesired radio wave may be reinforced. Alternatively, in a case in which the control apparatus 20 is not able to acquire the position information of the communication apparatus, the reflective plate 10 reflects the undesired radio waves without performing appropriate phase control. As a result, the phase of the reflected wave may overlap the phase of the undesired radio wave, reinforcing the undesired radio wave. In this case, the terminal apparatus may issue an alert to prompt the user holding the terminal apparatus to move. The alert may be, for example, vibrating the terminal apparatus or outputting sound from a speaker.

As described above, the control apparatus 20 according to the fourth example embodiment determines the phase of the reflected wave transmitted from the reflective plate 10 on the basis of the distance between the control apparatus 20 and the communication apparatus so that the reflected wave reaching the communication apparatus can cancel the undesired radio wave in the communication apparatus. As a result, the control apparatus 20 can reduce the interference in the communication apparatus that receives the undesired radio waves.

### Fifth Example Embodiment

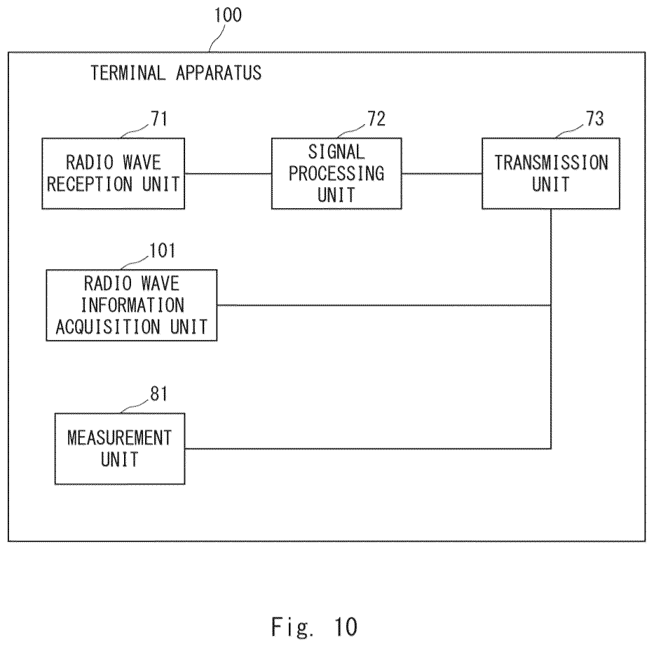

Next, a configuration example of the terminal apparatus 100 according to a fifth example embodiment will be described with reference to FIG. 10. The terminal apparatus 100 has a configuration in which a radio wave information acquisition unit 101 is added to the terminal apparatus 80 of FIG. 8. In the following description, functions and operations which are different from those of the terminal apparatus 80 will be mainly described.

The radio wave information acquisition unit 101 acquires information about the undesired radio waves. The information about the undesired radio waves may include specifications of the undesired radio waves. The specifications of the undesired radio wave may include, for example, the position of the transmission apparatus 60 transmitting the undesired radio wave, the frequency of the undesired radio wave, and the phase information of the undesired radio wave. The phase information of the undesired radio wave may include, for example, information indicating a phase when the transmission apparatus 60 transmits the undesired radio wave. Further, the specifications of the undesired radio wave may include information indicating a period of time during which the transmission apparatus 60 continuously transmits the undesired radio wave.

The radio wave information acquisition unit 101 may acquire the information about the undesired radio waves by demodulating the radio signal received from the transmission apparatus 60. Alternatively, the radio wave information acquisition unit 101 may acquire the information by demodulating the radio signal received from the base station 50. For example, the base station 50 may transmit a radio signal including the information about the undesired radio waves transmitted around the base station 50 to the terminal apparatus 100. Alternatively, the radio wave information acquisition unit 101 may retain in advance the information about the undesired radio waves. For example, in a case in which the transmission apparatus 60 is a satellite base station or the like in which the presence of the transmission apparatus 60 is known in advance, the terminal apparatus 100 may store the specifications of the undesired radio waves transmitted by the transmission apparatus 60 in a memory or the like in advance. Alternatively, the terminal apparatus 100 may receive the specifications of the undesired radio wave from a server that manages the specifications of the undesired radio wave via the base station 50.

The transmission unit 73 transmits information indicating the specifications, the interference state, and the necessity of canceling of the received radio wave received by the radio wave reception unit 71 to the control apparatus 90. The transmission unit 73 may perform wireless communication to transmit information to the control apparatus 40. For example, the transmission unit 73 may transmit information to the control apparatus 90 via the base station 50. In this case, it is assumed that the control apparatus 90 is connected to a network constructed by a communication service provider that manages the base station 50. Alternatively, the transmission unit 73 may perform wireless communication using a frequency different from the frequency used for communication with the base station 50, and transmit information to the control apparatus 90.

The specifications of the received radio wave may include the specifications of the desired radio wave and the specifications of the undesired radio wave, or may include only the specifications of either the undesired radio wave or the desired radio wave. The interference state may be a value of the SNR or the SINR, or may be information indicating a level of interference state. The necessity of canceling may be information indicating whether or not it is necessary to reduce interference in the terminal apparatus 70. For example, in a case in which the SNR or the SINR falls below a predetermined threshold value, the signal processing unit 72 may determine that canceling is necessary because interference is occurring. In a case in which the SNR or the SINR exceeds a predetermined threshold value, the signal processing unit 72 may determine that canceling is unnecessary because no interference is occurring or there is no influence from the interference.

Next, functions and operations of the control apparatus 90 according to the fifth example embodiment will be described. Here, the functions and operations of the control apparatus 90 according to the fifth example embodiment will be described using the configuration of the control apparatus 90 of FIG. 9.

The reception unit 41 receives the information indicating the specifications of the received radio wave, the interference state, and the necessity of canceling from the terminal apparatus 100. Furthermore, the reception unit 41 receives the position information of the terminal apparatus 100 from the terminal apparatus 100. The reception unit 41 may receive the pose information and the movement information of the terminal apparatus 100 together with the position information of the terminal apparatus 100. The specifications of the received radio wave may include the specifications of the desired radio wave and the specifications of the undesired radio wave, or may include only the specifications of either the undesired radio wave or the desired radio wave.

In a case in which the specifications of the undesired radio wave are not included in the specifications of the received radio wave received from terminal apparatus 100, the reception unit 41 may acquire the information about the undesired radio wave by demodulating the radio signal received from the transmission apparatus 60. Alternatively, the reception unit 41 may retain in advance the information about the undesired radio waves. For example, in a case in which the transmission apparatus 60 is a satellite base station or the like in which the presence of the transmission apparatus 60 is known in advance, the control apparatus 90 may store the specifications of the undesired radio waves transmitted by the transmission apparatus 60 in a memory or the like in advance. Alternatively, the control apparatus 90 may receive the specifications of the undesired radio wave from a server that manages the specifications of the undesired radio wave via an IP network such as the Internet.

The phase calculation unit 42 changes the phase of the reflected wave on the basis of the specifications of the undesired radio wave and the distance between the RIS reflective plate 30 and the terminal apparatus 100. Specifically, the phase calculation unit 42 specifies the phase when the undesired radio wave reaches the terminal apparatus 100 by using the phase when the transmission apparatus 60 transmits the undesired radio wave and the distance between transmission apparatus 60 and terminal apparatus 100. Further, the phase calculation unit 42 calculates the phase of the reflected wave which is shifted by half a wavelength compared to the undesired radio wave reaching the terminal apparatus 100. In a case in which the reflected wave transmitted from the RIS reflective plate 30 reaches the terminal apparatus 100, the phase calculation unit 42 calculates the phase of the reflected wave transmitted from the RIS reflective plate 30 so as to become the phase of the reflected wave which is shifted by half a wavelength compared to the undesired radio wave reaching the terminal apparatus 100.

The undesired radio wave includes a carrier wave component and a baseband component. The phase calculation unit 42 may control a phase of the carrier wave component of the reflected wave so that the reflected wave cancels the carrier wave component of the undesired radio wave reaching the terminal apparatus 100.

In order to reduce the interference caused by the undesired radio waves including irregularly changing baseband components, the reflected waves that are the undesired radio waves reflected by the RIS reflective plate 30 need to reach the terminal apparatus 100 at substantially the same timing as the undesired radio waves reaching the terminal apparatus 100. However, the undesired radio wave reaching the terminal apparatus 100 without being reflected by the RIS reflective plate 30 and the undesired radio wave reaching the terminal apparatus 100 after being reflected by the RIS reflective plate 30 have different propagation path distances. Therefore, it is unlikely that the reflected wave that is the undesired radio wave reflected by the RIS reflective plate 30 and the undesired radio wave that reaches the terminal apparatus 100 without being reflected by the RIS reflective plate 30 reach the terminal apparatus 100 at substantially the same timing.

Therefore, the phase calculation unit 42 can control the phase of the carrier wave component of the reflected wave having a constant amplitude and a constant phase speed such that the carrier wave component of the undesired radio wave reaching the terminal apparatus 100 can be canceled. As a result, the terminal apparatus 80 can reduce the interference generated in the terminal apparatus 100.

The control unit 43 electrically controls the reflective elements disposed on the surface of RIS reflective plate 30 so as to become the phase calculated by the phase calculation unit 42.

As described above, the control apparatus 90 according to the fifth example embodiment acquires the specifications of the undesired radio wave from the terminal apparatus 100, the server, or the like. Further, the control apparatus 90 determines the phase of the reflected wave transmitted from the RIS reflective plate 30 so that the wavelength of the reflected wave reaching the terminal apparatus 100 is shifted by half a wavelength compared to the wavelength of the undesired radio wave reaching the terminal apparatus 100. As a result, the interference caused by the undesired radio waves in the terminal apparatus 100 is reduced, and thus the communication quality between the terminal apparatus 100 and the base station 50 can be maintained good.

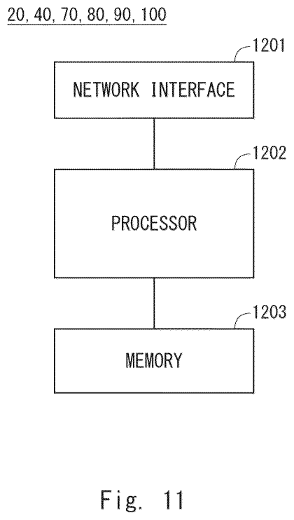

FIG. 11 is a block diagram illustrating a configuration example of the control apparatus 20, the control apparatus 40, the terminal apparatus 70, the terminal apparatus 80, the control apparatus 90, and the terminal apparatus 100 (hereinafter, referred to as the control apparatus 20 and the like) described in the above-described example embodiments. Referring to FIG. 11, the control apparatus 20 and the like includes a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 performs the processes of the control apparatus 20 and the like described using the flowcharts in the above-described example embodiments, by reading software (computer programs) from the memory 1203 and executing the software. The processor 1202 may be, for example, a microprocessor, a MPU, or a CPU. The processor 1202 may include a plurality of processors.

The memory 1203 is configured with a combination of a volatile memory and a nonvolatile memory. The memory 1203 may include a storage disposed away from the processor 1202. In this case, the processor 1202 may access the memory 1203 through an input/output (I/O) interface (not shown).

In the example in FIG. 11, the memory 1203 is used to store a group of software modules. The processor 1202 can perform the processing of the control apparatus 20 and the like described in the above-described example embodiment by reading and executing these software module groups from the memory 1203.

As described with reference to FIG. 11, each of the processors included in the control apparatus 20 and the like in the above-described example embodiments executes one or a plurality of programs including a command group for causing a computer to perform the algorithm described with reference to the drawings.

In the above-described example, the program includes a group of instructions (or software code) for causing a computer to perform one or more functions described in the example embodiments when being read by the computer. The program may be stored in a non-transitory computer readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communications medium. As an example and not by way of limitation, the transitory computer readable medium or the communication medium includes electrical, optical, acoustic, signals, or propagated signals in other forms.

Note that the present disclosure is not limited to the above-described example embodiments, and can be appropriately modified without departing from the scope.

Some or all of the above-described example embodiments may be described as in the following Supplementary Notes, but are not limited to the following Supplementary Notes.

### (Supplementary Note 1)

A radio wave control system including:
a reflective plate configured to reflect an undesired radio wave that causes interference for a communication apparatus;
control means for causing a reflected wave of the undesired radio wave to be transmitted in a direction in which the communication apparatus is present; and
communication means for receiving interference information indicating an interference state in the communication apparatus,
wherein the control means determines a phase of the reflected wave reaching the communication apparatus by using the interference information.

### (Supplementary Note 2)

The radio wave control system according to Supplementary Note 1,
wherein the control means increases an amount of change in the phase of the reflected wave as the interference state in the communication apparatus worsens.

### (Supplementary Note 3)

The radio wave control system according to Supplementary Note 1 or 2, wherein
the communication means acquires position information of the communication apparatus, and
the control means determines the phase of the reflected wave on the basis of the change amount in a position of the communication apparatus.

### (Supplementary Note 4)

The radio wave control system according to any one of Supplementary Notes 1 to 3, wherein
the communication means acquires position information of the communication apparatus, and
the control means increases an amplitude of the reflected wave as the position of the communication apparatus is farther from the reflective plate.

### (Supplementary Note 5)

The radio wave control system according to any one of Supplementary Notes 1 to 4, wherein the control means determines the phase of the reflected wave by electrically controlling reflective elements periodically disposed on the reflective plate.

### (Supplementary Note 6)

A radio wave control system including:
a reflective plate configured to reflect an undesired radio wave that causes interference for a communication apparatus; and
control means for causing a reflected wave of the undesired radio wave to be transmitted in a direction in which the communication apparatus is present,
wherein the control means determines a phase of the reflected wave reaching the communication apparatus by using information indicating a phase when the undesired radio wave reaches the communication apparatus and information indicating a distance from the reflective plate to the communication apparatus.

### (Supplementary Note 7)

The radio wave control system according to Supplementary Note 6, wherein the control means calculates the phase of the reflected wave so that the reflected wave reaches the communication apparatus, shifted by half a wavelength compared to the undesired radio wave reaching the communication apparatus.

### (Supplementary Note 8)

The radio wave control system according to Supplementary Note 6 or 7, wherein the control means determines a phase of a carrier wave component of the reflected wave.

### (Supplementary Note 9)

A control apparatus including:
control means for causing a reflected wave of an undesired radio wave, which is transmitted from a reflective plate configured to reflect the undesired radio wave that causes interference for a communication apparatus, to be transmitted in a direction in which the communication apparatus is present; and
communication means for receiving interference information indicating an interference state in the communication apparatus,
wherein the control means determines a phase of the reflected wave reaching the communication apparatus by using the interference information.

### (Supplementary Note 10)

The control apparatus according to Supplementary Note 9, wherein the control means increases an amount of change in the phase of the reflected wave as the interference state in the communication apparatus worsens.

### (Supplementary Note 11)

A control method including:
causing a reflected wave of an undesired radio wave, which is transmitted from a reflective plate configured to reflect the undesired radio wave that causes interference for a communication apparatus, to be transmitted in a direction in which the communication apparatus is present;
receiving interference information indicating an interference state in the communication apparatus; and
determining a phase of the reflected wave reaching the communication apparatus by using the interference information.

### (Supplementary Note 12)

A non-transitory computer readable medium having a program stored therein, the program causing a computer to execute:
causing a reflected wave of an undesired radio wave, which is transmitted from a reflective plate configured to reflect the undesired radio wave that causes interference for a communication apparatus, to be transmitted in a direction in which the communication apparatus is present;
receiving interference information indicating an interference state in the communication apparatus; and
determining a phase of the reflected wave reaching the communication apparatus by using the interference information.
10 REFLECTIVE PLATE
20 CONTROL APPARATUS
21 CONTROL UNIT
22 COMMUNICATION UNIT
30 RIS REFLECTIVE PLATE
40 CONTROL APPARATUS
41 RECEPTION UNIT
42 PHASE CALCULATION UNIT
43 CONTROL UNIT
50 BASE STATION
60 TRANSMISSION APPARATUS
70 TERMINAL APPARATUS
71 RADIO WAVE RECEPTION UNIT
72 SIGNAL PROCESSING UNIT
73 TRANSMISSION UNIT
74 RADIO WAVE INFORMATION ACQUISITION UNIT
75 MEASUREMENT UNIT
80 TERMINAL APPARATUS
81 MEASUREMENT UNIT
90 CONTROL APPARATUS
91 MEASUREMENT UNIT
92 POSITION CALCULATION UNIT
100 TERMINAL APPARATUS
101 RADIO WAVE INFORMATION ACQUISITION UNIT

What is claimed is:

1. A radio wave control system comprising:
a reflective plate configured to reflect an undesired radio wave that causes interference for a communication apparatus;
at least one memory storing instructions, and
at least one processor configured to execute the instructions to;
cause a reflected wave of the undesired radio wave to be transmitted in a direction in which the communication apparatus is present; and
receive interference information indicating an interference state in the communication apparatus,
determine a phase of the reflected wave reaching the communication apparatus by using the interference information.

2. The radio wave control system according to claim 1, wherein the at least one processor is further configured to execute the instructions to increase an amount of change in the phase of the reflected wave as the interference state in the communication apparatus worsens.

3. The radio wave control system according to claim 1, wherein the at least one processor is further configured to execute the instructions to
acquire position information of the communication apparatus, and
determine the phase of the reflected wave on the basis of the change amount in a position of the communication apparatus.

4. The radio wave control system according to claim 1, wherein the at least one processor is further configured to execute the instructions to
acquire position information of the communication apparatus, and
increase an amplitude of the reflected wave as the position of the communication apparatus is farther from the reflective plate.

5. The radio wave control system according to claim 1, wherein the at least one processor is further configured to execute the instructions to determine the phase of the reflected wave by electrically controlling reflective elements periodically disposed on the reflective plate.

6. A radio wave control system comprising:
a reflective plate configured to reflect an undesired radio wave that causes interference for a communication apparatus;
at least one memory storing instructions, and
at least one processor configured to execute the instructions to;
cause a reflected wave of the undesired radio wave to be transmitted in a direction in which the communication apparatus is present,
determine a phase of the reflected wave reaching the communication apparatus by using information indicating a phase when the undesired radio wave reaches the communication apparatus and information indicating a distance from the reflective plate to the communication apparatus.

7. The radio wave control system according to claim 6, wherein the at least one processor is further configured to execute the instructions to calculate the phase of the reflected wave so that the reflected wave reaches the communication apparatus, shifted by half a wavelength compared to the undesired radio wave reaching the communication apparatus.

8. The radio wave control system according to claim 6, wherein the at least one processor is further configured to execute the instructions to determine a phase of a carrier wave component of the reflected wave.

9-10. (canceled)

11. A control method comprising:
causing a reflected wave of an undesired radio wave, which is transmitted from a reflective plate configured to reflect the undesired radio wave that causes interference for a communication apparatus, to be transmitted in a direction in which the communication apparatus is present;
receiving interference information indicating an interference state in the communication apparatus; and
determining a phase of the reflected wave reaching the communication apparatus by using the interference information.

12. (canceled)

13. The control method according to claim 11, wherein an amount of change in the phase of the reflected wave is increased as the interference state in the communication apparatus worsens.

14. The control method according to claim 11, further comprising:
acquiring position information of the communication apparatus, wherein
the phase of the reflected wave is determined on the basis of the change amount in a position of the communication apparatus.

15. The control method according to claim 11, further comprising:
acquiring position information of the communication apparatus, and
increasing an amplitude of the reflected wave as the position of the communication apparatus is farther from the reflective plate.

16. The control method according to claim 11, wherein the phase of the reflected wave is determined by electrically controlling reflective elements periodically disposed on the reflective plate.
